(19) United States
(12) Patent Application Publication
(10) Pub. No.: US 2016/0171093 A1
(43) Pub. Date: Jun. 16, 2016

(54) EMAIL MINING SYSTEM

(71) Applicant: LEADGNOME, LLC, Acton, MA (US)

(72) Inventor: Matthew L. Benati, Acton, MA (US)

(21) Appl. No.: 14/886,741

(22) Filed: Oct. 19, 2015

Related U.S. Application Data
(60) Provisional application No. 62/092,036, filed on Dec. 15, 2014.

(51) Int. Cl. G06F 17/30; G06F 17/27; H04L 12/58

(52) U.S. Cl. CPC G06F 17/30684; H04L 51/08; G06F 17/2705; G06F 17/30569

(57) ABSTRACT

An improved technology in the form of a method and system automatically transforms unstructured, free form, emails into lead data and other account data useful for business applications, such as marketing, training, support, or the like. The method includes receiving emails in a system in which lead and account information is provided and, with a data mining and natural language parser, automatically identifying lead and account information. The lead and account information is optionally stored in a database, and is provided to designated personnel.

### CROSS-REFERENCE TO RELATED APPLICATION(S)

This application claims priority to, and the benefit of, co-pending U.S. Provisional Application 62/092,036, filed Dec. 15, 2014, for all subject matter common to both applications. The disclosure of said provisional application is hereby incorporated by reference in its entirety.

### FIELD OF THE INVENTION

The present invention relates to targeted account data and lead records, e.g., for business purposes. In particular, the present invention relates to an improved technology capable of transforming emails into account data and lead records.

### BACKGROUND

Generally, sales and marketing email campaigns are used for marketing a commercial message to individuals or organizations using email lists. Sales and marketing email campaigns may be used for customer acquisition, to build customer loyalty, stimulate sales, or brand awareness. Typically, companies collect, rent, or buy a list of customer or prospect email addresses to direct promotional messages. In addition to customer email address lists, many email newsletter software vendors offer transactional email support, which gives companies the ability to include promotional messages within the body of transactional emails. Software vendors often offer specialized transactional email marketing services, which include providing targeted and personalized transactional email messages and running specific marketing campaigns.

However, this methodology experiences some shortcomings. Traditionally, known data mining services mine data from form emails (e.g., name:value pairs) but not unstructured free form data included within the emails, such as when individuals author their own out of office messages. Currently, data mining out of office (OOO) emails obtained in response to email campaigns is not utilized and cannot be optimized using conventional technologies. In particular, data mining OOO emails requires a human to manually open, read, identify, and copy relevant information into either a spreadsheet or directly into their Customer Relationship Manager (CRM), Email Service Provider (EPS), Marketing Automation Systems (MAS), or Account Based Marketing solution. As a result, this data is not typically data mined because the data mining process is too labor intensive and costly to do so manually and, because the prior available technology is insufficient to facilitate such a process in a reliable manner.

### SUMMARY

Accordingly, there is a need for a technological solution capable of automatically leveraging the lead and account information included in the unstructured free form data included in, e.g., response emails to an email marketing campaign, such as by automatically transforming emails into useable sources of data and lead records for business uses, including sales and marketing teams, training, support, or the like. The present invention is directed toward further solutions to address this need, in addition to having other desirable characteristics. Specifically, in accordance with an example embodiment of the present invention, a method for automatically transforming emails into lead record data is provided. A computer hardware device receives a plurality of emails. The computer hardware device identifies at least one type of email from the plurality of emails. The method also includes a natural language parser executing on a processor transforming the at least one type of email into relevant information data by parsing the relevant information data from an unstructured free form body of the at least one type of email identified. The method further includes an intelligent inference module executing on a processor transforming the relevant raw information data into recognized data formats and common elements. The computer hardware device stores the transformed at least one type of email into a standardized, persistent data store for retrieval, reporting, and analytics. Then the computer hardware device further transforms the data to generate and output a uniquely created the lead record data with data originating from the parsed relevant information data and the recognized data formats and common elements.

According to aspects of the present invention the at least one type of email includes at least one of a direct inbound email, an out of office (OOO) email, a left the company email, an unsubscribe or opt-out email, a change of address email, a bounce back email, a, and a to all email. According to further aspects of the present invention the relevant information data for the at least one type of email includes at least one of a first name, a last name, a title, an email address, a phone number, a social media handle, a Uniform Resource Identifier (URI), a physical address, an out of office start date, an out of office end date, redirected contact information, and reason for being out of office. According to other aspects of the present invention the step of the recognized data formats and common elements includes at least one of email address formats and corporate mail addresses. Aspects of the present invention include restricting the at least one type of email, and restricting the at least one type of email includes restricting at least one of a support email address and other non-person email. According to further aspects of the present invention, transforming the relevant information data into recognized data formats and common elements includes leveraging the data mining to draw inferences about the relevant information in the plurality of emails. According to other aspects of the present invention, the natural language parser utilizes a library or database for identifying key patterns in the relevant information data from unstructured free form body. According to aspects of the present invention, the library or database include at least one of grammatical rules, common phrases, prefix and suffix phrases, predefined rules, and dictionary data. Further aspects of the present invention include a web verification module executing on a processor for verifying and augmenting the lead record data for accuracy and completeness. According to other aspects of the present invention, a formatting module executes on a processor and transforms the lead record data into a readable format of a third party customer relationship, marketing, and email applications.

In accordance with an example embodiment of the present invention, a system including a data mining engine operating on a computer hardware device is provided. The data mining engine identifies at least one email of a particular type from a plurality of emails and extracts unstructured free-form data in one or more fields in the at least one email. The system also includes a natural language parser operating on a computer hardware device and configured for transforming the unstructured free-form data from the at least one email into relevant information data by parsing relevant data from the unstructured free-form data. The system further includes an intelligent inference module operating on a computer hardware device and configured for transforming the parsed relevant information data into recognized data formats and common elements and generating and outputting lead record data. The system includes a web verification module operating on a computer hardware device and configured for verifying and augmenting the lead record data for accuracy and completeness. The system also includes a formatting module operating on a computer hardware device and configured for transforming the lead record data into a readable format of a third party customer relationship, marketing, and email applications.

According to aspects of the present invention the at least one email of a particular type comprises at least one of a direct inbound email, a left the company email, an unsubscribe or opt-out email, a change of address email, an out of office (OOO) email, a bounce back email, a, and a to all email. According to other aspects of the present invention the relevant information data for the at least one email of a particular type includes at least one of a first name, a last name, a title, an email address, a phone number, a social media handle, a Uniform Resource Identifier (URI), a physical address, an out of office start date, an out of office end date, redirected contact information, and reason for being out of office. According to further aspects of the present invention the recognized data formats and common elements comprise at least one of email address formats and corporate mail addresses. According to aspects of the present invention the system includes restricting the at least one type of email, the restricting the at least one type of email comprises restricting at least one of a support email address and an email address for a user located in a foreign country. According to other aspects of the present invention the natural language parser utilizes a library or database for identifying key patterns in the relevant information data from unstructured free form body. According to further aspects of the present invention the library or database include at least one of grammatical rules, common phrases, prefix and suffix phrases, predefined rules, and dictionary data.

In accordance with an example embodiment of the present invention, a non-transitory computer readable storage device having instructions stored thereon is provided, wherein execution of the instructions causes at least one processor to perform a method for automatically transforming emails into lead record data. The method includes a computer hardware device that receives a plurality of emails. The computer hardware device identifies at least one email of a particular type from the plurality of emails. The method also includes a natural language parser executing on a processor that transforms the at least one type of email into relevant information data by parsing the relevant information data from an unstructured free form body of the at least one type of email identified. The method further includes an intelligent inference module executing on a processor that transforms the relevant information data into recognized data formats and common elements. The computer hardware device stores the transformed at least one type of email into a standardized, persistent data store for retrieval, reporting, and analytics and outputs a lead record with data originating from the parsed relevant information data and the recognized data formats and common elements.

According to aspects of the present invention the at least one email of a particular type includes at least one of a direct inbound email, an out of office (OOO) email, a left the company email, an unsubscribe or opt-out email, and a change of address email and the relevant information data for the at least one email of a particular type includes at least one of an out of office start date, an out of a first name, a last name, a title, an email address, a phone number, a social media handle, a Uniform Resource Identifier (URI), a physical address, office end date, redirected contact information, and reason for being out of office.

### BRIEF DESCRIPTION OF THE FIGURES

These and other characteristics of the present invention will be more fully understood by reference to the following detailed description in conjunction with the attached drawings, in which:

FIG. 1 is an illustrative environment for implementing the steps in accordance with embodiments of the invention;

FIG. 2 is an illustrative environment for implementing the steps in accordance with embodiments of the invention;

FIG. 3 is an illustrative flowchart depicting operation of a data mining system configured to mine data from emails, in accordance with aspects of the invention; and

FIG. 4 is a diagrammatic illustration of a high level architecture for implementing processes in accordance with aspects of the invention.

### DETAILED DESCRIPTION

An illustrative embodiment of the present invention relates to an improved technology for handling emails, e.g., for providing businesses with targeted account data and lead records. Specifically, the present invention relates to a technological improvement for automatically transforming emails into account data and lead records by data mining and analyzing unstructured free form data from, e.g., particular types of emails received. The particular types of emails may include out of office reply emails, unsubscribe emails, reply, reply to all emails, direct inbound emails, a leaving the company email, an unsubscribe or opt-out email, a change of address email, etc., whether automatically or manually generated in response to an initial marketing email, or other email source. The transforming of the emails can include a specific facet of emails, such as reply emails created in response to an email marketing distribution. The data from the particular types of emails may be leveraged to generate lead records and account information for new contacts or new information for existing contacts. For example, unstructured free form data included in an out of office email may be leveraged to obtain, dates when the recipient will be available (e.g., returning from out of office), reasons why the recipient is out of the office, additional contact information for the recipient, job title of the recipient, and/or new contacts which may be referenced in the out of office email (e.g., please direct immediate concerns to Joe). Moreover, the lead records may include additional information that may be leveraged similarly from each of the email types, such as first name, last name, title, company, email address, contact phone number of the new lead. Advantageously, the lead records and account information has the potential to increase account penetration, accelerate existing opportunities, create new opportunities, and ultimately increase revenue, which are valuable capabilities to sales and marketing teams across all industries and markets, as well as for other business purposes, such as training or support. Prior to the present invention, there was no technological solution providing a way to transform the unstructured free form data in various types emails (e.g., reply emails) into useful account records and lead records.

Additionally, the lead record information data mined from emails may supplement the existing lead record information to increase connection rates and conversion rates of the lead targets. Specifically, the lead record information may be used in conjunction with other applications used by the sales or marketing personnel to improve sales opportunities. For example, data mined from an out of office reply email may be used such that the sales and marketing personnel will be tasked with contacting the lead once the individual returns from being out of the office (e.g., by setting alerts in an electronic calendar). Similarly, an email for an employee leaving a company or a change of address email can be mined to delete and/or change data in the existing lead records information data (e.g., remove a company email address for an individual or updating an individual's new address).

The present invention utilizes an analytic engine with a data mining engine, a natural language parser, and an intelligent inference module to obtain the lead record information. The analytic engine is designed to ingest emails e.g., resulting from email marketing campaigns. Once the emails are ingested and stored, the analytic engine may identify which email types should be targeted for analysis. For example, the analytics engine may identify all of the out of office email replies received in response from an email marketing campaign. Thereafter, the analytics engine may data mine unstructured free form data (e.g., data from subject line, body, etc. of the email) from the out of office reply emails for important relevant data (e.g., data relevant to creating or supplementing lead records). The data mining may be performed by a combination of the data mining engine and natural language parser. The data mining engine and natural language parser are able to identify and capture important and relevant data as they relate to new or existing lead records, from the out of office emails. The captured important and relevant data may be passed to an intelligent inference module which may generate new lead records and/or fill in any gaps in the lead records. For example, the intelligent inference module may infer an email contact for a new lead by combining identified formats and common data from the recipient's email address and a first and last name of a new lead obtained from the body of the out of office email. The out of office email lead is discussed with respect to the present invention, however as would be appreciated by one of ordinary skill in the art, the present invention is not intended to be limited to the use of out of the office response emails and can include any type of emails.

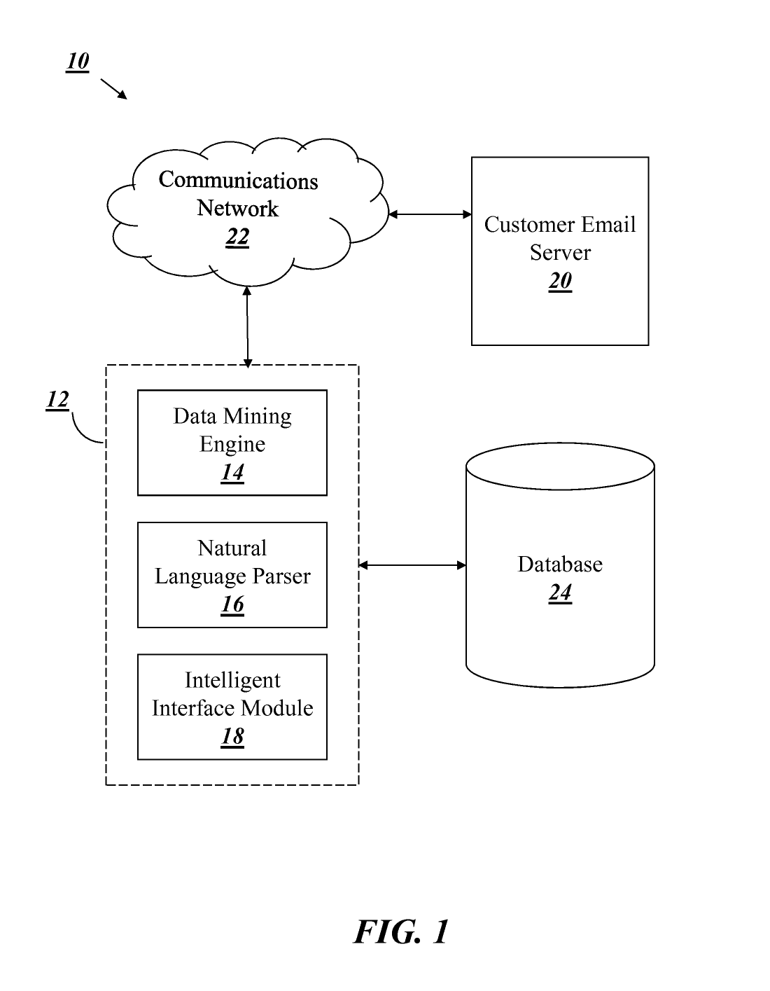

FIGS. 1 through 4, wherein like parts are designated by like reference numerals throughout, illustrate an example embodiment or embodiments of an improved technology capable of automatically transforming emails into account data and lead records, according to the present invention. Although the present invention will be described with reference to the example embodiment or embodiments illustrated in the figures, it should be understood that many alternative forms can embody the present invention. One of skill in the art will additionally appreciate different ways to alter the parameters of the embodiment(s) disclosed, in a manner still in keeping with the spirit and scope of the present invention.

FIG. 1 is a high level architecture for implementing processes in accordance with aspects of the present invention. Specifically, FIG. 1 depicts a computing system 10 (e.g., a data mining system) including an analytics engine 12 comprising a data mining engine 14, a natural language parser 16, and an intelligent inference module 18. The analytics engine 12 may operate on a general purpose computer or a specialized computer system. For example, the analytics engine 12 may include a single computing device, a collection of computing devices in a network computing system, a device utilizing a cloud computing infrastructure, or a combination thereof. As would be appreciated by one of skill in the art, the analytics engine may include or otherwise be connected to the data mining engine 14, the natural language parser 16, and the intelligent inference module 18. As would be appreciated by one of skill in the art, the data mining engine 14, the natural language parser 16, and the intelligent inference module 18 also may include one or more computing devices (e.g., one or more computing devices as discussed with respect to analysis engine 12). In accordance with an example embodiment, the analytics engine 12 may be a computing system operated by a service provider.

In operation, the analytics engine 12 may be configured to receive a plurality of emails (e.g., ReplyTo emails, direct inbound emails, etc.) from a customer email server 20. For example, the analytics engine 12 may receive emails in response to an email marketing campaign performed by the customer email server 20 (e.g., an exchange server). The customer email server 20 may include one or more computing devices (e.g., one or more computing devices as discussed with respect to analytics engine 12). The analytics engine 12 and the customer email server 20 may be configured to establish a connection and communicate over telecommunication network(s) 22. As would be appreciated by one of skill in the art, the telecommunication network(s) 22 may include any combination of known networks. For example, the telecommunication network(s) 22 may be combination of a mobile network, Wireless Access Network (WAN), Local Area Network (LAN), or other type of network. Similarly, in accordance with an example embodiment, the telecommunication network(s) 22 may be used to exchange data between the analytics engine 12, the data mining engine 14, the natural language parser 16, and the intelligent interface module in a cloud environment.

The analytics engine 12 may be further configured to identify email types within the received response emails. For example, the analytics engine 12 may be able to identify direct inbound emails, a left the company email, an unsubscribe or opt-out email, a change of address email, out of office emails, bounce back emails, reply, reply to all responses, unsubscribe requests, no longer works here, etc. The email types may be recognized by identifying particular words and/or phrases in a subject line or body of the response emails. In accordance with an example embodiment, the analytics engine 12 may store the received emails and identified email types within a database 24. For example, the analytics engine 12 can use data from the emails to build a table in the database 24 to be used in additional transformation and processing steps. As would be appreciated by one of skill in the art, the database 24 may include any combination of computing devices configured to store and organize a collection of data. For example, the database 24 may be a local storage device on the analytics engine 12, a remote database facility, or a cloud computing storage environment. As one of skill in the art will appreciate, although reference is made herein to a single database 24, the database 24 may be implemented across multiple logically connected different databases, which can be locally or remotely coupled. The database 24 may also include a database management system utilizing a given database model configured to interact with a user for analyzing the database data.

Continuing with respect to FIG. 1, the data mining engine 14 may be configured to identify email components that may include important unstructured free form data to be used for lead records. Specifically, the data mining engine 14 may access the identified email types from the received emails in the database 24 and perform an analysis to identify data fields, of that the email type, that may include unstructured free form data. For example, the data mining engine 14 may identify fields of a response email corresponding to a sender of the response email, a subject line of the response email, a body of the email, a signature block of the email, and the data contained therein. The identified email components or fields and the corresponding data contained therein may be updated in the database 24 and/or passed to the natural language parser 16 for additional analysis.

The natural language parser 16 may be configured to perform analysis of the unstructured free form data in the emails to determine which information included in the emails is relevant. The natural language parser 16 may use pattern recognition and/or dictionaries to parse particular words, phrases, names, number or a combination thereof that are determined to be relevant information according to predetermined criteria. For example, the relevant information for lead records may include first name, last name, email address, company name, title, office phone, mobile phone, main phone, fax number, office address, instant messaging addresses, social media profile/handle, a Uniform Resource Identifier (URI), a physical addresses, accounts, list of direct reports, list of management (e.g., who the sender of a response email reports to), and referring person (e.g., the original target of an email marketing campaign). As would be appreciated by one skilled in the art, the relevant information for lead records can include any information deemed valuable to the customer and/or service provider. In accordance with an example embodiment, the natural language parser 16 may have predetermined criteria for particular email types. For example, the relevant information for an out of office reply email may include the relevant information for the lead records and an out of office start date, out of office end date, reason for being out of office, and list of redirected contact information. In accordance with an example embodiment, the natural language parser 16 may also restrict out particular data as not being relevant according to the predetermined criteria. For example, predetermined criteria identifying support email addresses, support phone numbers, sales email addresses, sales phone numbers, or other non-person specific data may be deemed as irrelevant and restricted out. The predetermined criteria for the lead records and the particular email types may be defined in customized dictionaries created for identification of key terms, phrases, numbers or related criteria. As would be appreciated by one skilled in the art, the predetermined criteria for each type of email can also be stored in the database 24 and accessed by the natural language parser 16.

The natural language parser 16 may utilize a combination of methods for determining which information included in the emails is relevant information based on the predetermined criteria. The determination of which data is relevant is may include mining data for new lead records or supplementing existing lead records. As would be appreciated by one of skill in the art, the methods may include utilizing artificial intelligence, machine learning statistics, database systems, or a combination thereof. The methods may also access a combination of libraries and/or databases using in accordance with or in addition to the predetermined criteria dictionaries to accurately identify relevant information. For example, the libraries or databases may include, key phrases, common expressions, linguistic patterns, prefix/suffix phrases, a nickname table, etc. The libraries or databases may also include customized pattern identifiers for pattern recognition, such that desired phrases, terms, words, numerals and their context are identified as relevant information. For example, when determining relevant data for the out of office reply emails, the libraries may include information for identifying dates, days of the week, pronouns, names, reasons for being out of the office, phone numbers. In accordance with aspects of the present invention, library and databases may be periodically updated with new identifiers (e.g., phrases). As would be appreciated by one of skill in the art, the libraries and databases may be different for each language and/or dialect. Once the relevant information has been identified and or gathered by the natural language parser 16 the relevant information may be updated in the database 24 and/or passed to an intelligent inference module 18 for additional analysis.

The intelligent inference module 18 may be configured to identify common elements within the relevant data received from the data mining engine 14 and the natural language parser 16 and derive formats and common data from the relevant lead record information. The intelligent inference module 18 may leverage the relevant information from the natural language parser 16 and transform the relevant data into recognized data format and common elements (e.g., email address formats, corporate mail address, phone numbers, etc.) to generate lead records. In particular, the intelligent inference module 18 of data mining system 10 can take a collection of data, from the natural language parser 16 or other source, and perform unconventional processing steps to transform the original data to create a new and uniquely useful set of data (e.g., lead records) which can be used to solve a particular problem (e.g., generating marketing leads from previously unutilized ReplyTo emails). The common elements include relevant data related to email address, office address, office telephone number, telephone extensions, and business instant messaging address. For example, the intelligent inference module 18 may infer a lead email address by combining a domain addresses from the response email sender with an individual's name identified by the natural language parser 16 in the body of an email. For example, from an email the natural language parser 16 can identify a domain email address for a company (e.g., @company.com), the format of the email (e.g., firstname.lastname@company.com), and a first and last name (John Doe) in the body of the email infer a new contact email (John.Doe@company.com) to create a new previously unknown lead record (e.g., John Doe, an employee at Company, with contact information of John.Doe@company.com). Additionally, the intelligent inference module 18 may be utilized to complete missing information from the lead records using the relevant information parsed from the unstructured free form email data. For example, continuing the above example, if a lead record exists for John Doe but there is no email contact for John Doe in the lead record, then the intelligent inference module 18 can infer that John Doe's email is John.Doe@company.com and update his lead record accordingly, as discussed herein. In accordance with an example embodiment, the data in the lead record that has been inferred by the intelligent inference module 18 may be tagged as inferred. The inferred items tagged for display to a user for review or may be tagged to trigger further verification. For example, an inferred email address may be tagged as inferred and cause a web verification and augmentation module 26 to initiate a process to verify the accuracy of the inferred information, as discussed in greater detail below.

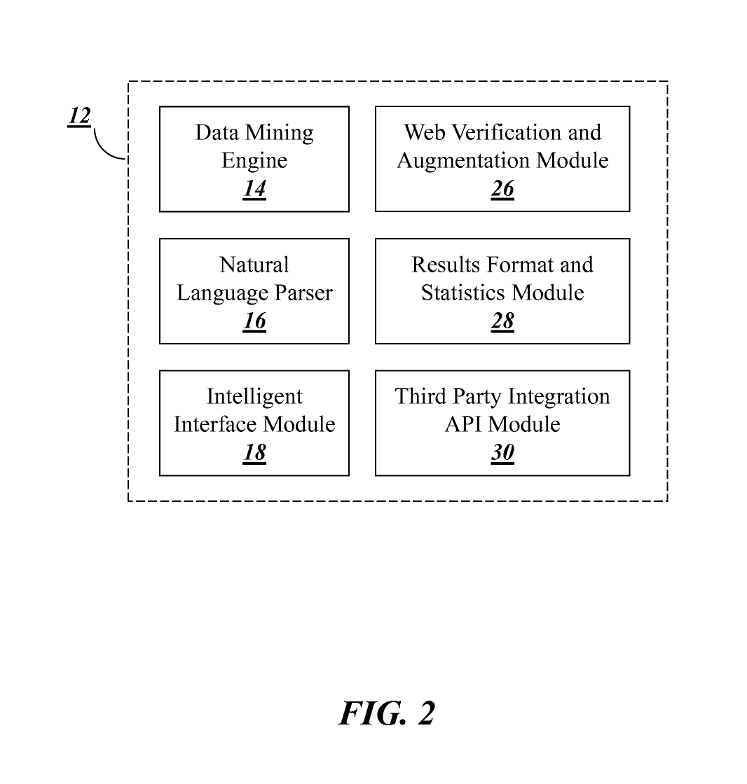

FIG. 2 is a high level architecture for implementing processes in accordance with aspects of the present invention. The architecture of FIG. 2 depicts additional architecture which may be implemented within or otherwise connected to the analytics engine 12, as discussed with respect to FIG. 1. Specifically, the analytics engine 12 may include additional modules for providing additional analysis and formatting of the data in the emails. In accordance with an example embodiment, the analytics engine 12 may include a web verification and augmentation module 26, a results format and statistics module 28, and a third party integration API module 30. The web verification and augmentation module 26 may be configured for verifying the lead records inferred by the intelligent inference module 18. The web verification and augmentation module 26 may perform the verification through web searches, social media searches, company employee directory searches, or other methods known in the art to confirm and/or add additional information to the lead records. Certain information may be required by sellers or marketers to properly segment the lead records. For example, if a lead record is missing a contact's job title, the web verification and augmentation module 26 may search a social media network for the lead records contact using an inferred email address to obtain the contacts job title. As would be appreciated by one of skill in the art, the web verification and augmentation module 26 may search for other information missing from the lead record, such as an office address, contact phone number etc. Similarly, the web verification and augmentation module 26 may be used to verify the accuracy of the lead record by comparing the lead record information to information identified in a web search. For example, the inferred job title in a lead record may be verified against a posted job title for the contact of the lead record on social media network. As would be appreciated by one of skill in the art, the web verification and augmentation module 26 could be a third party service provider or may be integrated as an additional module of the analytics engine 12.

Additionally, the analytics engine 12 may also include a results format and statistics engine 28. The results format and statistics module 28 may be configured to provide transformation of the lead record data and/or perform statistical analysis of the lead record data. The transformation of the lead record data may include converting the lead record data into a format readable to third party applications for use by the customer's email server 20. For example, the lead record data may be filtered and downloaded into a Comma Separate Values (CSV) format with rows associated with each lead record and columns associated with a different field (e.g., mobile phone number or email address) for use by a third party application. The CSV format creates a consistent data format for use by a user or third party application. For example, all the data related to dates may be filtered and formatted in a consistent matter (e.g., Month/Day/Year). The lead record data may also be formatted in other formats for use by third party applications such as formats readable by CRM, MAS, and ESP.

The transformed lead record data may also be utilized by the format and statistics module 28 to provide various metrics and statistics to a user. The lead record data may be transformed to create a new specialized collection of information data such that the information data may be presented visually (e.g., using a pie chart or bar diagram) to show various statistics, trends, or percentages related to the lead record data gathered by the emails (e.g., through a marketing campaign). For example, format and statistics module 28 may produce bar charts depicting how successful or unsuccessful a particular email campaign was in producing marketing leads. The aggregated lead records may also be used to improve marketing segmentation. For example, the format and statistics module 28 may produce a pie chart depicting the percentages of each job titles were found in the lead records that were produced (e.g., 10% sales rep, 50% managers, 25% CEOs, 15% CFOs). Accordingly, the statistics module 28 can be used to customize marketing campaigns. For example, the statistics module 28 can identify particular positions within a company (e.g., high ranking officers, a specific position being held, etc.) and then the identified leads associated with the particular positions can be targeted in future marketing campaigns.

Continuing with FIG. 2, the analytics engine 12 may further include a third party integration API module 30. The third party integration API module 30 may be used to transform or export the aggregated lead records from the results format and statistics module 28 to be used with third party applications of the customer. The transformed record leads may be transmitted to the customer's email server 20 using an API interface to export the record lead data for use by one or more third party applications (e.g., CRM, MAS, ESP). For example, the third party integration API module 30 may leverage public APIs using login credentials of the customer to login to the customer email server 20 over the network 22 and update the customer lead records with the new lead records created by the analytics engine 12. Thereafter, the customer's email server 20 may be able to download and make the lead records available for use by sales and marketing personnel.

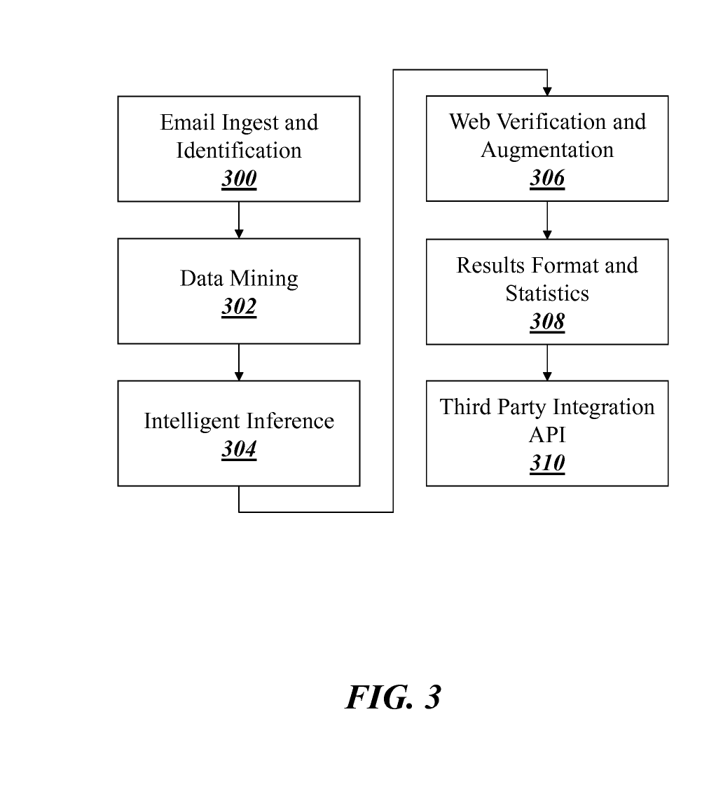

FIG. 3 shows an exemplary flow chart depicting implementation of the present invention. Specifically, FIG. 3 depicts an exemplary flow chart showing the operation of the analytics engine 12 and its associated modules/engines, as discussed with respect to FIGS. 1 and 2. In particular, FIG. 3 depicts a process of transforming emails into lead record information that includes ingesting emails (e.g., ReplyTo emails resulting from an email marketing campaign), data mining the ingested emails, drawing intelligent inferences about the mined data to generate new lead record information, verifying and augmenting the lead record information, transforming the lead record information into a third party application readable format, and transmitting the lead record information to the originator of the email marketing campaign.

The process depicted in FIG. 3 is initialized by a user (e.g., a customer) sending out an email marketing campaign. The email marketing campaign is configured such that a target email associated with the data mining system 10 is included in the ReplyTo email distribution list of the marketing campaign, such that the data mining system 10 will receive email responses to the email marketing campaign. The target email may be included in the ReplyTo email distribution list of the email marketing campaign such that the response emails are received and collected in a unique or shared email folder of the data mining system 10. The unique or shared email inbox may be implemented by using comma separated value (CSV) files or a modifier symbol (e.g., “+”) to define the target email address of the data mining system 10. For example, a shared inbox configuration would require the ReplyTo email distribution list to use a target email constructed as <data mining>+<customer name>@<domain name>.<domain type>, such that the reply emails are received and collected in the appropriate email folder of the analytics engine 12 of a domain of the service provider for analysis. The unique inbox configuration can require the ReplyTo email distribution list to use a target email constructed as <customer name>@<domain name>.<domain type>, such that the reply emails are received and collected in the email folder of the analytics engine 12 of a domain of the service provider for analysis. Advantageously, the “customer name” within the target email may identify the customer for which the data mining service is being provided by the data mining system 10.

At step 300, the response emails (e.g., ReplyTo emails) to the email marketing campaign are received, ingested and identified at the analytics engine 12 on the data mining system 10. As would be appreciated by one skilled in the art, the emails can received without being prompted by another process (e.g., an email marketing campaign) and the process depicted in FIG. 3 can be applied to any type of emails. The ingesting may include storing and transforming the response emails into a standardized, persistent data store for easy retrieval (e.g., in database 24), reporting, and analytics. For example, the analytics engine 12 may store the response emails in a dedicated email inbox associated with the customer. Thereafter, at least one reply type of the received email responses may be automatically identified. For example, out of office reply emails may be identified as at least one of the reply types. Advantageously, the automatically identified reply type emails may be data mined for lead record information.

At step 302, the identified reply emails are data mined for relevant information. The data mining may be performed by a combination of the data mining engine 14 and the natural language parser 16 or other method known in the art, as discussed with respect to FIG. 1. The data mining engine 14 may be responsible for determining and capturing which data in the identified reply emails is relevant. The identifying may include mining data from unstructured free form data included in the various fields of the reply email. As would be appreciated by one of skill in the art, the data mining may also include chunking the body(s) of the reply emails and breaking the chunks into tokens for use by the natural language parser 16. The natural language parser 16 may be responsible for analyzing and pattern matching the unstructured free form data to determine which key words or phrases are relevant for marketing purposes. For example, the natural language parser 16 may use one or more libraries to identify names, email addresses, contact phone numbers, referenced contacts, etc., as discussed with respect to FIG. 1. The natural language parser 16 may also restrict certain data as being irrelevant. For example, information related to support, sales, or other non-specific person data may be determined to be irrelevant and then restricted, as discussed with respect to FIG. 1. The resulting data from the data mining engine 14 and the natural language parser 16 are used to derive lead records by transforming the resulting data, as discussed with respect to FIG. 1.

At step 304, the mined data lead records from step 302 are further analyzed using the intelligent inference module 18. The intelligent inference module 18 may leverage the data within the lead records to derive formats and common data (e.g., email address formats). The derived formats and common data may be used by the intelligent inference module 18 to inferred additional information for the lead records, as discussed with respect to FIG. 1, The additional information may be used to supplement and/or complete the lead records. For example, the intelligent inference module 18 may be able to construct an individual's corporate email address by combining a derived email format with an individual's name. The inferred portions of the lead records may be tagged as inferred and passed on to the web verification and augmentation module 26 for additional analysis.

At step 306, the web verification and augmentation module 26 can review the lead records for accuracy and completeness. The web verification and augmentation module 26 may use a combination of web searches, social media searches, and/or corporate employee directory searches to verify and/or augment the inferred lead records data, as discussed with respect to FIG. 2. The web verification and augmentation module 26 may also use a combination of searches to complete partially complete missing information from the lead records, as discussed with respect to FIG. 2.

At step 308, the data is transformed into a standardized format and key statistics are derived for analysis, reporting and visualization purposes by the results format and statistics module 28. The transforming of the lead record data may include converting the lead record data into a format readable to third party applications for use by the customer, as discussed with respect to FIG. 2. The formatted data may be passed onto the third party integration API module 30 to transmit the lead record data to the customer. Additionally, the results format and statistics module 28 may transform the lead record data such that the information may be presented visually (e.g., using a pie chart or bar diagram) to show various statistics, trends, or percentages related to the lead record data gathered by the email marketing campaign.

At step 310, the data is transformed by the third party integration API module 30 for third part integration and transmitted using a third party's API, as discussed with respect to FIG. 2. Specifically, the third party integration API module 30 may be used to format or export the aggregated lead records from the results format and statistics module 28 to be used with third party applications of the customer. The formatted record leads may be transmitted to the customer using an API interface to export the record lead data for use by one or more third party applications (e.g., CRM, MAS, ESP). Thereafter, the sales and marketing personnel may be able to use one or more third party applications to further manipulate and utilize the derived lead records.

### Examples of Operation

In an exemplary implementation of the present invention response emails are received by the analytics engine 12 resulting from an email marketing campaign initiated by the customer. A determination is made that lead records derived from out of office emails are desired (e.g., input from the service provider, customer, etc.). All of the out of office response emails from a ReplyTo of an email campaign are identified and fields of those emails including free form data are identified and subsequently mined by the data mining engine 14. Thereafter, the free form data from those emails are analyzed by the natural language parser 16. For example, an out of office email is sent from John Doe's email account (John.Doe@company.com) indicates that John Doe is out of the office from Jan. 1, 2015 until Jan. 10, 2015 for vacation and that important matters should be forwarded to Jane Doe. The data mining engine 14 may identify the sender, subject line, body of the email, and signature line as including free form data that may be of importance. The natural language parser 16 may identify relevant information from the free form data in the identified fields, including John Doe's email address (e.g., John.Doe@company.com), the dates John Doe is out of the office (e.g., Jan. 1, 2015 until Jan. 10, 2015), the reason John Doe is out of the office (e.g., vacation) and the forwarding contact (e.g., Jane Doe). Thereafter, the intelligent inference module 18 may identify the company email domain as @company.com and infer that the email has a format of “firstname.lastname” based on John.Doe and his corresponding signature line indicating his name as John Doe. Combining the forwarding contact name of Jane Doe and the inferred email format (e.g., firstname.lastname@company.com), the intelligent inference module 18 may infer that Jane Doe's email address as Jane.Doe@company.com. Accordingly, using the out of office response email from John Doe, the analytics engine 12 may be able to create a new lead contact for Jane Doe. Additionally, the new lead information for Jane Doe may be supplementing and/or verified by the web verification and augmentation module, as discussed with respect to FIGS. 1 and 3. As would be appreciated by one of skill in the art, the above example is not intended to be limiting and is presented to show an exemplary representation of the present invention.

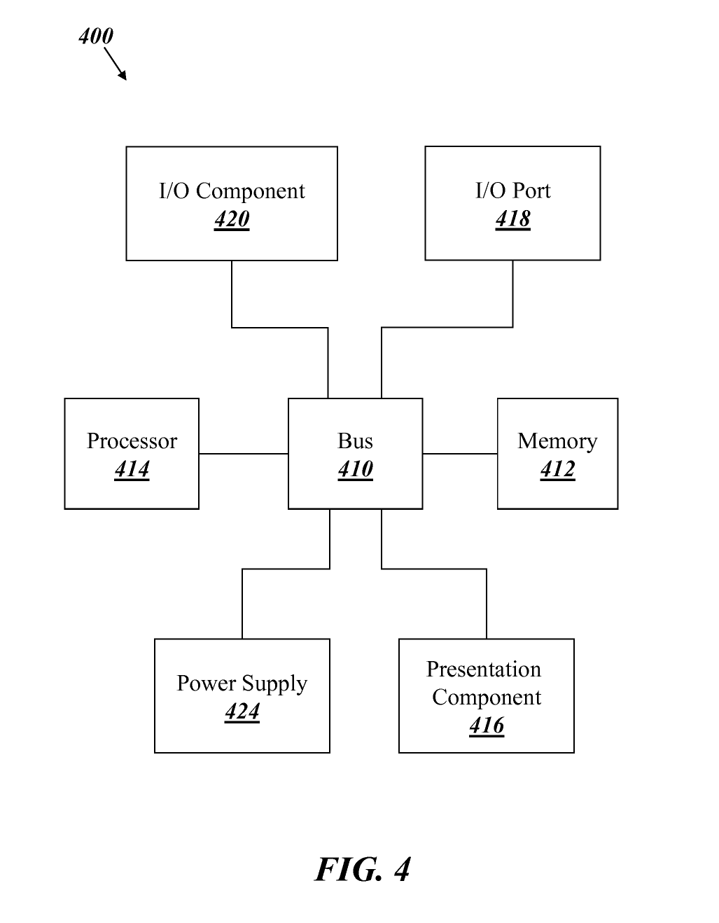

Any suitable computing device appropriately configured can be used to implement the computing devices (including analytics engine 12 and the customer email server 20) and methods/functionality described herein. One illustrative example of such a computing device 400 is depicted in FIG. 4. The computing device 400 is merely an illustrative example of a suitable computing environment and in no way limits the scope of the present invention. A “computing device,” as represented by FIG. 4, can include a “workstation,” a “server,” a “laptop,” a “desktop,” a “hand-held device,” a “mobile device,” a “tablet computer,” or other computing devices, as would be understood by those of skill in the art. Given that the computing device 400 is depicted for illustrative purposes, embodiments of the present invention may utilize any number of computing devices 400 in any number of different ways to implement a single embodiment of the present invention. Accordingly, embodiments of the present invention are not limited to a single computing device 400, as would be appreciated by one with skill in the art, nor are they limited to a single type of implementation or configuration of the example computing device 400.

The computing device 400 can include a bus 410 that can be coupled to one or more of the following illustrative components, directly or indirectly: a memory 412, one or more processors 414, one or more presentation components 416, input/output ports 418, input/output components 420, and a power supply 424. One of skill in the art will appreciate that the bus 410 can include one or more busses, such as an address bus, a data bus, or any combination thereof. One of skill in the art additionally will appreciate that, depending on the intended applications and uses of a particular embodiment, multiple of these components can be implemented by a single device. Similarly, in some instances, a single component can be implemented by multiple devices. As such, FIG. 4 is merely illustrative of an exemplary computing device that can be used to implement one or more embodiments of the present invention, and in no way limits the invention.

The computing device 400 can include or interact with a variety of computer-readable media. For example, computer-readable media can include Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices that can be used to encode information and can be accessed by the computing device 400.

The memory 412 can include computer-storage media in the form of volatile and/or nonvolatile memory. The memory 412 may be removable, non-removable, or any combination thereof. Exemplary hardware devices are devices such as hard drives, solid-state memory, optical-disc drives, and the like. The computing device 400 can include one or more processors that read data from components such as the memory 412, the various I/O components 416, etc. Presentation component(s) 416 present data indications to a user or other device. Exemplary presentation components include a display device, speaker, printing component, vibrating component, etc.

The I/O ports 418 can allow the computing device 400 to be logically coupled to other devices, such as I/O components 420. Some of the I/O components 420 can be built into the computing device 400. Examples of such I/O components 420 include a microphone, joystick, recording device, game pad, satellite dish, scanner, printer, wireless device, networking device, and the like.

As utilized herein, the terms “comprises” and “comprising” are intended to be construed as being inclusive, not exclusive. As utilized herein, the terms “exemplary”, “example”, and “illustrative”, are intended to mean “serving as an example, instance, or illustration” and should not be construed as indicating, or not indicating, a preferred or advantageous configuration relative to other configurations. As utilized herein, the terms “about” and “approximately” are intended to cover variations that may existing in the upper and lower limits of the ranges of subjective or objective values, such as variations in properties, parameters, sizes, and dimensions. In one non-limiting example, the terms “about” and “approximately” mean at, or plus 10 percent or less, or minus 10 percent or less. In one non-limiting example, the terms “about” and “approximately” mean sufficiently close to are deemed by one of skill in the art in the relevant field to be included. As utilized herein, the term “substantially” refers to the complete or nearly complete extend or degree of an action, characteristic, property, state, structure, item, or result, as would be appreciated by one of skill in the art. For example, an object that is “substantially” circular would mean that the object is either completely a circle to mathematically determinable limits, or nearly a circle as would be recognized or understood by one of skill in the art. The exact allowable degree of deviation from absolute completeness may in some instances depend on the specific context. However, in general, the nearness of completion will be so as to have the same overall result as if absolute and total completion were achieved or obtained. The use of “substantially” is equally applicable when utilized in a negative connotation to refer to the complete or near complete lack of an action, characteristic, property, state, structure, item, or result, as would be appreciated by one of skill in the art.

As utilized herein, the terms “comprises” and “comprising” are intended to be construed as being inclusive, not exclusive. As utilized herein, the terms “exemplary”, “example”, and “illustrative”, are intended to mean “serving as an example, instance, or illustration” and should not be construed as indicating, or not indicating, a preferred or advantageous configuration relative to other configurations. As utilized herein, the terms “about” and “approximately” are intended to cover variations that may existing in the upper and lower limits of the ranges of subjective or objective values, such as variations in properties, parameters, sizes, and dimensions. In one non-limiting example, the terms “about” and “approximately” mean at, or plus 10 percent or less, or minus 10 percent or less. In one non-limiting example, the terms “about” and “approximately” mean sufficiently close to be deemed by one of skill in the art in the relevant field to be included. As utilized herein, the term “substantially” refers to the complete or nearly complete extend or degree of an action, characteristic, property, state, structure, item, or result, as would be appreciated by one of skill in the art. For example, an object that is “substantially” circular would mean that the object is either completely a circle to mathematically determinable limits, or nearly a circle as would be recognized or understood by one of skill in the art. The exact allowable degree of deviation from absolute completeness may in some instances depend on the specific context. However, in general, the nearness of completion will be so as to have the same overall result as if absolute and total completion were achieved or obtained. The use of “substantially” is equally applicable when utilized in a negative connotation to refer to the complete or near complete lack of an action, characteristic, property, state, structure, item, or result, as would be appreciated by one of skill in the art.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. Within this specification embodiments have been described in a way which enables a clear and concise specification to be written, but it is intended and will be appreciated that embodiments may be variously combined or separated without parting from the invention. It is intended that the present invention be limited only to the extent required by the appended claims and the applicable rules of law.

It is also to be understood that the following claims are to cover all generic and specific features of the invention described herein, and all statements of the scope of the invention which, as a matter of language, might be said to fall therebetween.

What is claimed is:

1. A method for automatically transforming emails into lead record data or account data, the method comprising:
a computer hardware device receiving a plurality of emails;
the computer hardware device identifying at least one type of email from the plurality of emails;
a natural language parser executing on a processor transforming the at least one type of email into relevant information data by parsing the relevant information data from an unstructured free form body of the at least one type of email identified;
an intelligent inference module executing on a processor transforming the relevant information data into recognized data formats and common elements;
the computer hardware device storing the transformed at least one type of email into a standardized, persistent data store for retrieval, reporting, and analytics; and
the computer hardware device generating and outputting the lead record data or account data with data originating from the parsed relevant information data and the recognized data formats and common elements.

2. The method of claim 1, wherein the at least one type of email comprises at least one of a direct inbound email, an out of office (OOO) email, a left the company email, an unsubscribe or opt-out email, a change of address email, a bounce back email, a reply, and a reply to all email.

3. The method of claim 2, wherein the relevant information data for the at least one type of email includes at least one of a first name, a last name, a title, an email address, a phone number, a social media handle, a Uniform Resource Identifier (URI), a physical address, an out of office start date, an out of office end date, redirected contact information, and reason for being out of office.

4. The method of claim 1, wherein the recognized data formats and common elements comprise at least one of email address formats and corporate mail addresses.

5. The method of claim 1, further comprising restricting the at least one type of email.

6. The method of claim 5, wherein the restricting the at least one type of email comprises restricting at least one of a support email address and other non-person email.

7. The method of claim 1, wherein transforming the relevant information data into the recognized data formats and common elements further comprises leveraging the data mining to draw inferences about the relevant information in the plurality of emails.

8. The method of claim 1, wherein the natural language parser utilizes a library or database for identifying key patterns in the relevant information data from unstructured free form body.

9. The method of claim 8, wherein the library or database include at least one of grammatical rules, common phrases, prefix and suffix phrases, predefined rules, and dictionary data.

10. The method of claim 1, further comprising a web verification module executing on a processor for verifying and augmenting the lead record data for accuracy and completeness.

11. The method of claim 1, further comprising a formatting module executing on a processor for transforming the lead record data into a readable format of a third party customer applications.

12. A system, comprising:
a data mining engine operating on a computer hardware device and configured for:
identifying at least one email of a particular type from a plurality of emails; and
extracting unstructured free-form data in one or more fields in the at least one email of a particular type;
a natural language parser operating on a computer hardware device and configured for transforming the unstructured free-form data from the at least one email of a particular type into relevant information data by parsing relevant data from the unstructured free-form data;
an intelligent inference module operating on a computer hardware device and configured for transforming the parsed relevant information data into recognized data formats and common elements and generating and outputting lead record data;
a web verification module operating on a computer hardware device and configured for verifying and augmenting the lead record data for accuracy and completeness; and
a formatting module operating on a computer hardware device and configured for transforming the lead record data into a readable format of a third party customer applications.

13. The system of claim 12, wherein the at least one email of a particular type comprises at least one of a direct inbound email, a left the company email, an unsubscribe or opt-out email, a change of address email, an out of office (OOO) email, a bounce back email, a reply, and a reply to all email.

14. The system of claim 13, wherein the relevant information data for the at least one email of a particular type includes at least one of a first name, a last name, a title, an email address, a phone number, a social media handle, a Uniform Resource Identifier (URI), a physical address, an out of office start date, an out of office end date, redirected contact information, and reason for being out of office.

15. The system of claim 12, wherein the recognized data formats and common elements comprise at least one of email address formats and corporate mail addresses.

16. The system of claim 12, further comprising restricting the at least one email of a particular type, the restricting the at least one email of a particular type comprises restricting at least one of a support email address and an email address for a user located in a foreign country.

17. The system of claim 12, wherein the natural language parser utilizes a library or database for identifying key patterns in the relevant information data from unstructured free form body.

18. The system of claim 17, wherein the library or database include at least one of grammatical rules, common phrases, prefix and suffix phrases, predefined rules, and dictionary data.

19. A non-transitory computer readable storage device having instructions stored thereon, wherein execution of the instructions causes at least one processor to perform a method for automatically transforming emails into lead record data, the method comprising:
a computer hardware device receiving a plurality of emails;
the computer hardware device identifying at least one email of a particular type from the plurality of emails;
a natural language parser executing on a processor transforming the at least one email of a particular type into relevant information data by parsing the relevant information data from an unstructured free form body of the at least one email of a particular type identified;
an intelligent inference module executing on a processor transforming the relevant information data into recognized data formats and common elements;
the computer hardware device storing the transformed at least one email of a particular type into a standardized, persistent data store for retrieval, reporting, and analytics; and
the computer hardware device generating and outputting a lead record with data originating from the parsed relevant information data and the recognized data formats and common elements.

20. The device of claim 19, wherein the at least one email of a particular type comprises at least one of a direct inbound email, an out of office (OOO) email, a left the company email, an unsubscribe or opt-out email, and a change of address email and the relevant information data for the at least one email of a particular type includes at least one of a first name, a last name, a title, an email address, a phone number, a social media handle, a Uniform Resource Identifier (URI), a physical address, an out of office start date, an out of office end date, redirected contact information, and reason for being out of office.
